(19) United States
(12) Patent Application Publication
(10) Pub. No.: US 2026/0021672 A1
(43) Pub. Date: Jan. 22, 2026

(54) Watermark Process for Preventing Digitally Enabled Fraud in Official Physical Documents

(71) Applicant: Alain Brice Niama, SEATAC, WA (US)

(72) Inventor: Alain Brice Niama, SEATAC, WA (US)

(21) Appl. No.: 19/275,741

(22) Filed: Jul. 21, 2025

Related U.S. Application Data
(60) Provisional application No. 63/673,577, filed on Jul. 19, 2024.

(51) Int. Cl. B41M 3/10; B41M 1/12; B41M 7/00; B42D 25/333; C09D 11/037

(52) U.S. Cl. CPC B41M 3/10; B41M 1/12; B41M 7/0081; B42D 25/333; C09D 11/037

(57) ABSTRACT

The present invention is directed towards a device and process for imprinting watermarks on physical documents. The process includes an adapter operating as a stencil and containing the watermarking material. A pen-like applicator is used to imprint the watermarking material through the stencil. The watermarking material is produced as a composition of plant components which are mixed while being treated with the application of heat and cold activation techniques.

### FIELD OF THE INVENTION

The present invention relates generally to the field of document security. Specifically, the present invention is a method for producing a watermark for physical documents which cannot be replicated through digital reproductions.

### BACKGROUND OF THE INVENTION

Climate change provides a challenge for modern society with likely catastrophic consequences for failing to address both the immediate environment and the underlying factors. The global community has put forth considerable effort to address the issue, including major international conferences organized by the United Nations. Atmospheric Carbon Dioxide (CO₂) has been identified as a major factor in how humans have influenced the climate and as the most important compound to address directly on the matter. CO₂ is a byproduct of both animal respiration and many industrial, economic, travel, and other technological activities. A simple solution is not going to be developed.

In an effort to develop practical solutions for an aspect of the outlined environmental issues, the present invention has been developed to convert a portion of the Carbon byproduct into a useful product. Specifically, the present invention is directed towards producing watermarks on physical documents which help secure against digitally aided fraud activities. This technology can be applied across several fields, such as identifying documents, financial instruments, certifications, and diplomas, or voting materials.

This is how I develop a device to secure authentic official documents to help differentiate a false document from the real one. This ended with a thermosetting plastic adapter associated with a tip to sign or affix a mark on a diploma or civil status document otherwise on a currency of the bank notes of all species. This invention is an extraordinary fact to fight against the fraud of administration documents which is nowadays a principle of fraudulent maneuvers, without forgetting administrative falsifications. This device is a system which extends to the protection of texts, for example in the drafting of state secrets. This process consists in making the security of the number in the telephone cards, lottery games for invisible numbers. It is used to adjust a draw during competitions as in sport. Natural products represent the experimental basis for the technology of this very scientific process. It all comes down to the supply of finished products by the workforce, training for job creation in the field of the fight against fraud. This issue helps for the security of architectural drawings and representations of plans such as diagrams. The expansion of epidemics is a source of unemployment in several areas. That is why the world should fight counterfeits together with attempts of the illicit acts reproached by the institutions for protection of various official documents. This adapter escapes universal electronic machines and this makes it possible to fight against the piracy of paper money, banknotes, and checks. Its writings become invisible during a fax transfer or after scanning a certificate. The scientific aspect of the invention is based on the strict composition of the ink. The composition of matter does not act on a document to sign with ink, but these ink molecules must write both on the document and in the document on the back. In fact, the energy level of the atoms is traversed by an external pressure of the tip without ink which mobilizes the ink by friction. This analysis is very convincing by the use of the volume of the ink during its decrease on the surface of the adapter by signing documents for a long time. This means that the volume of the ink is proportional to its surface volume.

Most of the inks written on the abandoned sheets contaminated the soil with toxic Macromolecules. This ink is not very chemical, and it does not produce the emission of CO₂ in thermal field. It is a real exception of carbon molecules without remarkable emission.

Simply affix a non-ink tip or pen to the bottom of the adapter to mark a sign, all of the surface of the banknote. To this end, if the sign affixed to the front of the surface of the banknote has the same limit on the back, this means is the real banknote. On the other hand, if the sign reacts only on the surface of the banknote it is the counterfeit banknote.

This adapter protects passports with more than ten functions. It detects falsification of bank documents such as fake checks. No computer as well as scanners could copy this ink mark. Not all fraud of administrative documents is possible by this indelible ink and invisible by the grip of digital machines.

The ink of this adapter can be used to make notebooks, both notebooks and the case of vaccination. The manufacturer of notebook sheets is a great exception. It would be the only notebook whose lines are invisible, both visible and indelible.

When the notebooks are crossed lines for writing, the traces of notebook placed on the table become visible, when the pages of notebook are observed high up in light or air the lines become translucent unlike in a closed room. It is a versatile and unusual notebook for use of practical workbooks.

Notebooks manufacturing factories facilitate the service of selling notebooks in the public market. These industries are using customers with the innovation of modem tools like scanners that help students photocopy notebook pages.

The industries also lose the benefit of customers by the absence of purchasing power of the students who no longer by to photocopy. The ink of the new adapter traces indelible lines which are produced nowhere and impossible to be scanned. This is a safety book that reacts in the same way as the watermark on banknotes. This is an ecological ink that does not cause stains whatever the pressure of friction.

The presidential elections are reversed and rigged by the satellite. If the ballot is signed by the ink of the adapter, the waves of the satellites would be impossible to copy it and translate the code. Ballot boxes can no longer be used as electoral fraud.

The molecules of this ink represent a very scientific structure of chemistry. This is explained by results exercise never seen scientific circle. This technology allows academics and researchers to understand new chemical knowledge.

This new scientific practice is a comparison with the formulas already known. By this great exception competent scientists could mention a revolution against piracy. This adapter transforms regular-sized white paper into a four-page double notebook sheet. It is an important exercise for making notebook pages without the use of industry.

The multifunctional adapter reacts such as a characteristic administrative role in several areas. This adapter is used to recognize whether a banknote conforms to strict and authorized use. Banks suffer from counterfeit money; hence banknotes of all communities are concerned.

This secure ink adapter guarantees transit mail to the postal agency and to the place of ballot box to avoid fraud overload. Each ballot in the envelope deserves to have the same ink code using the remaining ink of a few centimeters of a unique signature.

The mail of the ballot is transferred to the polls. It is therefore impossible that the ink deposited with this non-existent signature is overloaded with fraud. It is quite convincing that this ink escapes from any copy of the original by scanning. The computer, scanner or copiers are unable to identify this security ink by its almost zero volume.

The big exception is the saving of ink to write lightly on a paper document. The real security of the ballot boxes concerns a system that does not exist in the competition of historical technologies.

Securing college degrees deserves the same invisible ink procedure when the certificate is submitted in the air. This test of raising the diploma higher makes the signature of this ink invisible.

The system can secure both stolen checks without money order from the owner. Banks should warn customer safety Instead of wasting time investigating late. This ink adapter blocks hacking of any kind of computerized receipts because the ink sign shows up on top and riverside of the original document.

This ink is invisible when it can write covered by two intermediate pages. This is also the reason that the capabilities and functions of this ink do not exist in history.

Here are the different tasks that can be done with these photocopiers. The first is the scanner allowing scanning of all types of documents such as photos or text. In this way, it is impossible to make any photocopy of the writings derived from this original ink. The second function is the printer which centralizes the printing of documents through the network. This connection system is not able to centralize this polyvalent ink.

The third is the photocopier itself that gives the employee the ability to copy documents in one or more copies, in various formats. There is still no way to make any format to copy this characterized ink capacities. Finally, the fax for receiving and transmitting documents by fax using an integrated modem. Fax system is insufficient to fax these multipurpose ink capabilities.

Other smart features may also be present on a multifunction copier. For example, built-in programs can be installed. They make it possible to monitor the printing fleet by noting the counter of the different copies made. Software can also be present to control print and feed management. Opting for a multifunction photocopier has a multitude of advantages such as obtaining a neat work, a great ease of use thanks to intuitive controls, a centralization of tasks and especially a considerable time saving and thus savings. Nothing of these functions can challenge these polyvalent multipurpose ink capacities in the case of doubling a falsified document.

A great print quality: Many possibilities in relation to the image, such as enlargement and reduction. The internal network of the company can be connected to the digital photocopier allowing the sharing of files, for example: back up documents directly to the internal hard disk. This context can be used fraud to traffic information or to share state secrets to enemy countries or terrorist. All this way cannot work because this new ink which is invisible and multipurpose escapes espionage sharing digital files.

Exceptional travel certificates are not easy to find without already being used. The already completed written certificate cannot be reused. As it is impossible to reuse a completed form for a second time, the certificate filled with the new ink of adapter disappears when the scanner is copied. It is still a scientific revolution to renew a certificate without buying twice or more the same paper.

This is remarkable to resume full use of the paper filling ready to throw in the trash. Otherwise, the same details would be maintained on the paper of the scan copy.

A rather spectacular remark is that the ink of the adapter is both a species of carbon which reacts without emitting carbon dioxide. The ink in the combustion of the papers in the garbage cans produces vapors to decompose the molecules of the smoke without the effects of CO2 in the atmosphere.

This exercise is comparable when on one side there is the test of burnt paper without ink, and on the other side the same weight of the papers written with the ink of the adapter. The observation is that the papers are associated with the ink of the adapter bum with a water vapor aspect comparably with the other with black smoke.

The state secrets of a country deserve to be secured by this ink sometime invisible of this adapter against piracy of high-tech machines or satellite use. This is the reason the new world needs to secure sensible writings.

It seems to be a first ink that has more functions with extraordinary technology. It is an ink visible on the front and back of certificate. It is also visible by the magnifying glass of the camera magnification, to the great surprise that its writings disappear in real time by reproduction.

This visible ink therefore cannot be picked up by machines because it escapes high-tech capacity machines. This is immensely helpful for a fair election.

An original certificate that is printed without the signature must be legalized by sending the photocopy of the original to the administration in charge of applying the anti-fraud ink. This is to reassure the legal owner after verification.

### DETAIL DESCRIPTIONS OF THE INVENTION

All illustrations of the drawings are for the purpose of describing selected versions of the present invention and are not intended to limit the scope of the present invention.

The untreated surface of the adapter is partially the prototype long before the complete form. In fact, the adapter is light tool of 250 grams and is much more shocking reducing. We distinguish three parts, the first of which is a plastic compound on the surface of the white paper.

The second part is to form the sheet layer at the bottom of the reverse side of paper surface. The third part is the white surface converted to a substance of the treatment of the gray color. This gray color of the operations of chemistry and physics finalizes the writing adapter. The entire shape of the adapter is shown in the attached photo.

The current adapter is a device according to the back of its model to write on the surface of the document. This is a procedure for securing administration documents.

The center of the adapter that impresses depends on tree barks and plant debris. If its bark is wet it must be dried by the ultraviolet radiations, or electric rays. This means the dry extract of the leaves with the solid wood crumbs.

Barks once dried and crushed by a Moline is excited. This is the dry extract of the raw material. Its bark is converted into a gray powder sensitive to carbon quite specified in color. This powder is deposited on a transparent sheet associated with the adapter paper such as the writing case.

Then filtered water is associated with this powder as a deposit with the fat of hot palm nuts. This mixture forms a kind of paste and grain which is excited by high intensity electric rays. The pump water must be heated by a water filter such as soluble ingredients.

The whole mixture with water and fat absorbs the electromagnetic rays. The atoms inside the powder grains molecules are excited in the liquid mixture. The electromagnetic source drifts from a radiant bulb of maximum power. The electrical transfer here is exerted by a thermal bulb maximum power of 1 000 watts. This electric charge is transferred in the dust atoms of the grains to form a slightly dark liquid layer. It means that the molecules of the crushed barks suck the electric charge of the light radiation.

### The Use of Cotton and Sugar Cane:

The cotton is heated in an electric pot with hot water. This cotton absorbs well heated water. Then this cotton becomes a cleaner after pressing it. The use of sugar cane is of paramount importance. It needs to cut sugar cane to store its macromolecules matter in the glass. The liquid macromolecule of sugar cane is so rich in cohesion with cotton. The macromolecule here is considered to be a raw juice of sugar cane.

### Heating of the Surface Composition of the Adapter:

It is an electromagnetic exercise associated with the stability of the writing board. The molecules of the composition of the writing board at this level must have approximately the same size and the same chemical equilibrium.

The molecules of synthesis represent a more or less dark aspect with the high size compared to the others. It is necessary to equalize the volume of the molecules by the electric rays.

The composition of the writing board once heated by electric rays there is debris on the surface like dust. All debris is simply cleaned by cotton to make the surface of the writing board smooth enough. It is the beginning of a formation of dry ink which forms.

To prevent this ink from causing smudges on documents of sheets, it is particularly important to subject this writing board to cooling.

### Cooling Training of the Adapter:

This is to expose the adapter in air conditioning of a fan. This control of the experiment cools the molecules of the writing board layer which has been warmed by the electric rays. In this exercise the molecules which are less welded reinforce the rigidity of their statistical cohesion. This system values the permanence or duration of the resistance of the ink to write as long as possible.

A portion of the cotton is immersed in the natural sugar juice entirely in the glass. This cotton is wet with sucrose squeezed in droplets on the raw mixture of the adapter.

The observation is that the volume of the surface of the adapter increases with all mixtures. The whole corresponds to a raw mixture on the surface of the adapter which represents the potential part of the writing board.

### Steaming Ice Cubes and Palm Oil Drops:

This part consists of roasting the palm nuts to collect amount of hot fat. The palm nuts discharge the fat in an aluminum pot onto an electric plate. This small quantity of hot fat is poured into the slice of dried cotton all in the aluminum pot. The cotton is then soaked with grease squeezed from the hand to the surface of the adapter. It should be remembered that the adapter already had a preliminary mixture associated with crushed carbon powder, water, sugar cane juice, nuts, and cotton.

The grease defines the temperature of the surface of the adapter and its mixture heats the solution. The rise in temperature excites the atoms in the molecules to increase their energy levels.

The ice cubes are manually suspending 20 centimeters high on the hot mixture of the adapter. This exercise discharges the ice cube from the droplets that spill onto the deposits or debris of the adapter. It is about a vapor entrainment which breaks the composition of the macromolecules of the hot products in the cooled temperature.

Palm nuts produce its hot fat in an electric pot before pouring it onto the surface of the adapter. The slice of ice cubes suspended in height of hand fall in droplets in the current mixture.

The thermal electric bulb is used to heat the surface products for the adapter. This product allows the mixture of solution to dry in thick volume of layer added. The mixture of products heated on the adapter is cooled by the blower wind of the fan. It is the conversion of the resistance of writing board under construction.

A slightly heated cotton swab is used to rub on the composition of the adapter as a means of dry cleaning. The whole of this technique stops at repeated cooling training of a fan.

Finally, a pen-shaped tip without ink enters the complete system of the writing case. It is a proof that a plastic and a simple metal tip can be used to save ink.

The plastic rod with the light metal tip without ink written on the back of the adapter to expose the writings on the surface of the adapter as on the document. It is almost a complete technology for securing bank documents and an adapter against identity crime before adding watermark in the carbon without pollution in use of electromagnetic light.

Ultimate Step of Water Mark Carbon Technology with Electric Power Distillation:

The device serves as the steam drive is a system of electromagnetic rays of appropriate bulbs which exert around a Pyrex glass the boiling of water molecules in vapor state which propel the carbon atoms associated with the surface of a flat filter cap super imposed a few centimeters in heigh. The frequency of the electric and magnetic light emits the thermal effect over a more or less short duration to heat the water from the Pyrex glass which in its vapor motion, carries away the carbon atoms associated on the metal part towards the filter of CO2 compounds.

The prototype designed to produce the carbon watermark is just an assembly of thermos-plastic pipes resistant to the heat of electromagnetic effect of the rays which infiltrates the entire system of conversion of the light debris of carbon powder combined with the vapor of the molecules of water.

The water distillation equipment has a double distiller like a glass Pyrex. The other is used to heat water and propel the Electromagnetic radiation from the bulb at ahigh temperature in the full path of the vapors towards the carbon atoms although there is no mass of dust up to the point where the carbon dioxide meets water vapors. This junction causes the multiplication of carbon atoms in the temperature while the motion of the vapors in full excitation of the rays emitted by electrons at a remarkable intensity.

The point of cohesion between the water vapors traveling through this system and the electric photons of the halogen lamps is characterized by the conservation of the temperature of the accelerated molecules in movement which absorb this energy of the electromagnetic light.

The entire, quite scientific exercise consists in fact of scraping zero grams of carbon which represents a group of negligible atoms taken from the ppm of polluting carbon to compose a watermark product having entirely ecological reactions of effects. This means that several zero grams of carbons atoms taken make it possible to decompose and erase the mass of environmental pollution included in the initial sensitive carbon to be polluted before scraping for its thermal and electric use.

The practical process is finalized by the combination of first phase carbon ingredients from wood waste and water mixtures supplemented with fats to result in the carbon layer on the surface of the carbon ink paper. This surface is set as a layer superimposed on a circle of thermosetting plastic used as a small filter tablet for distillation of the last phase.

This phase of mixing of the jets of electric photons in the distillation vapors on the one hand and on the other hand, the propagation of the electromagnetic rays which excite the carbon atoms associated with the model of the light metallic part of zero gram of carbon propelled all along with thermal light while the mixture of vapors.

All the carbons and vapors in the electromagnetic light fuse into the carbon filter to exert the new molecules. This is the mixture in the form of a layer installed by the pressure of vapors and carbon dioxide (CO2) whose reaction depends on hand pressure by a rod above an unprinted paper to bring out the traces of watermark carbon. In other words, it is a question of opposing the energy vapors to the electromagnetic effect of a distillation whose source is high intensity light at full speed towards a carbon gas and air whose source is also thermal lamps with electromagnetic rays.

After having converted the water into steam to join its vapors to the minimum of CO2 in full flow at the Junction point which is the combination of the all vapors and carbon dioxide.

Droplets appear around the filter and inside the small holes which form the ink of the watermark reaction. This ink reacts by cluttering the interior filter, the upper part of which is flat with a dry friction of a solid or a point which traces on a paper superimposed on this absorption surface of watermark carbon.

It is the contact of the rod or appoint without ink on the surface of the flat filter which represents a security code for any document or official paper such as accounting certificate, civil status document or diploma as well as the ballot boxes against piracy of satellite internet system or imitations on copies of scanners.

Although the invention has been explained in relation to its preferred embodiment, it is to be understood that many other possible modifications and variations can be made without departing from the spirit and scope of the invention.

1. A process which produces watermarks on physical documents, the steps comprising:
Providing a physical document;
Providing an adapter stencil comprising a plastic compound, a sheet layer, and an application surface;
Providing a writing tip unexposed to ink;
Impressing an ink substitute material onto the physical document using the writing tip via the application surface of the writing adapter stencil;
wherein
the ink substitute material comprises a composition of dried matter derived from multiple distinct plant materials;
the ink substitute material being crushed into a powder and deposited in the sheet layer of the adapter stencil;
a suspension of heated palm nut fat in filtered water is mixed with the powder and excited by electromagnetic waves.
